(19) United States
(12) Patent Application Publication
(10) Pub. No.: US 2009/0047045 A1
(43) Pub. Date: Feb. 19, 2009

(54) IMAGE FORMING APPARATUS

(75) Inventors: So Won Sheen, Seoul (KR); Won Wook Lee, Seoul (KR)

Correspondence Address: DLA PIPER LLP US, P. O. BOX 2758, RESTON, VA, 20195, US

(73) Assignee: SAMSUNG ELECTRONICS CO., LTD., SUWON-SI (KR)

(21) Appl. No.: 12/111,269

(22) Filed: Apr. 29, 2008

(30) Foreign Application Priority Data
Aug. 17, 2007 (KR) 10-2007-0082731

(51) Int. Cl. G03G 15/09

(52) U.S. Cl. 399/267; 399/272; 399/273

(57) ABSTRACT

An image forming apparatus capable of collecting residual toner from the donor roller by means of a plurality of magnetic rollers and consequently, reducing the occurrences of possible ghost phenomenon caused by the toner residue. The image forming apparatus includes an image receiving member having an electrostatic latent image formed on a surface thereof, a donor roller to receive a toner and form a layer of toner on an outer circumferential surface thereof, the donor roller being arranged to oppose the image receiving member so as to develop with toner the electrostatic latent image of the image receiving member, and a plurality of magnetic rollers each to support magnetic brushes of carrier.

### CROSS-REFERENCE TO RELATED APPLICATION

This application claims the benefit of Korean Patent Application No. 2007-0082731, filed on Aug. 17, 2007, in the Korean Intellectual Property Office, the disclosure of which is incorporated herein by reference.

### BACKGROUND OF THE INVENTION

1. Field of the Invention

The present invention relates to an image forming apparatus, and, more particularly, to an image forming apparatus to form an image by means of developing agent composed of nonmagnetic toner and magnetic carrier.

2. Description of the Related Art

An image forming apparatus is an apparatus to form an image on a printing medium, e.g., a sheet of paper, from data or signal representing the image. In an image forming apparatus, developing agent is introduced to an electrostatic latent image formed on an image receiving member in order to develop the electrostatic latent image into a visible image, and thereafter, the developed visible image is transferred and fixed onto a printing medium.

An example of a conventional image forming apparatus is disclosed in U.S. Patent Application Publication No. US 2007/0003328 to Kurogawa et al. (“Kurogawa”), which describe an image forming apparatus including an image forming unit, which forms an image on paper by the use of developing agent composed of nonmagnetic toner and magnetic carrier.

The image forming unit described by Kurogawa includes an exposure unit to irradiate a laser beam containing image information onto an image receiving member to form thereon an electrostatic latent image, a magnetic roller, the magnetic force thereof causing a magnetic brush of carrier to form and a donor roller to develop the electrostatic latent image on the image receiving member with toner received via the magnetic brush formed on the magnetic roller.

In the legacy devices, e.g., one disclosed by Kurogawa, however, while some of the residual toner particles remaining on the donor roller after the development of the electrostatic latent image may be collected by the magnetic brush on the magnetic roller, a sufficient amount of the residual toner remain on the donor roller. This portion of the residual toner remaining on the donor roller may cause a ghost phenomenon, in which at least some portions of a previously printed image may appear as if it is a part of the current image.

### SUMMARY OF THE INVENTION

It is thus an object of the invention to provide an image forming apparatus, which can more effectively collect residual toner that remains on the donor roller after the process of developing the electrostatic latent image is completed.

Additional aspects and/or advantages of the invention will be set forth in part in the description which follows and, in part, will be obvious from the description, or may be learned by practice of the invention.

In accordance with an aspect of the invention, the above and/or other aspects can be achieved by the provision of an image forming apparatus comprising: an image receiving member on which an electrostatic latent image is to be formed; a donor roller configured to receive toner, and to carry a layer of the toner on an outer circumferential surface thereof, the donor roller being arranged to opposingly face the image receiving member to cause the toner to be applied from the donor roller onto the electrostatic latent image of the image receiving member; and a plurality of magnetic rollers, each of which being arranged to face the donor roller, and being configured to apply a magnetic force to cause a magnetic brush of carrier to be formed.

The magnetic rollers may comprise: a first magnetic roller located at a first location along the direction of rotation of the donor roller, and a second magnetic roller located at a second location along the rotating direction of the donor roller. The first location being further away from the development gap formed between the donor roller and the image receiving member than the first location.

The second magnetic roller may be spaced apart from the first magnetic roller to receive the carrier from the first magnetic roller.

The first magnetic roller may comprise a pair of first magnetic poles both of the first polarity that are arranged, in parallel, on opposite sides of an imaginary line that passes through the respective center of the first and second magnetic rollers, and the second magnetic roller may comprise a second magnetic pole disposed along the imaginary line, the second magnetic pole being a second polarity opposite the first polarity.

A first agitator may be disposed below the first magnetic roller and be used to transmit the toner and the carrier to the first magnetic roller, and a second agitator may be disposed below the second magnetic roller and be used to transmit the toner and the carrier to the first agitator.

In accordance with another aspect of the present invention, there is provided an image forming apparatus comprising: an image receiving member on which an electrostatic latent image is to be formed; a donor roller configured to receive toner, and to carry a layer of the toner on an outer circumferential surface thereof, the donor roller being arranged to opposingly face the image receiving member to cause the toner to be applied from the donor roller onto the electrostatic latent image of the image receiving member; a first magnetic roller to supply the toner to the donor roller; and a second magnetic roller to collect a residue of toner that remains on the donor roller after the toner had been applied to the electrostatic latent image.

The first magnetic roller may be located at a first location along the rotating direction of the donor roller, and the second magnetic roller may be located at a second location along the rotating direction. The first location being further away from the development gap formed between the donor roller and the image receiving member than the first location.

In accordance with yet another aspect, there is provided an developer unit for developing, with developing agent that includes a mixture of nonmagnetic toner particles and magnetic carrier particles, an electrostatic latent image formed on an image receiving member of an image forming apparatus, the developer unit comprising: a first magnetic roller configured to induce a first magnetic force to carry thereon a first magnetic brush formed of the magnetic carrier particles, the nonmagnetic toner particles being carried by the magnetic brush; a donor roller disposed in proximity to, and spaced apart from, the first magnetic roller, the donor roller being rotatably mounted to rotate about a rotational axis in a rotational direction, the donor roller having an outer circumferential surface to receive the nonmagnetic toner particles from the magnetic brush of the first magnetic roller; and a second magnetic roller disposed in proximity to, and spaced apart from, each of the donor roller and the first magnetic roller, the second magnetic roller being configured to receive from the first magnetic roller the magnetic carrier particles, the second magnetic roller further being configured to induce a second magnetic force to from thereon a second magnetic brush formed of the magnetic carrier particles, the second magnetic brush receiving nonmagnetic toner particles from the donor roller.

### BRIEF DESCRIPTION OF THE DRAWINGS

These and/or other aspects and advantages of the exemplary embodiments of the invention will become apparent and more readily appreciated from the following description of the embodiments, taken in conjunction with the accompanying drawings, of which:

FIG. 1 is a sectional view schematically illustrating an image forming apparatus according to an embodiment of the present invention;

FIG. 2 is an enlarged view of the portion II of FIG. 1; and

FIG. 3 is a sectional view illustrating a donor roller and magnetic rollers provided in an image forming apparatus according to another embodiment of the present invention.

### DETAILED DESCRIPTION OF THE PREFERRED EMBODIMENTS

Reference will now be made in detail to an exemplary embodiment of the present invention, examples of which are illustrated in the accompanying drawings, wherein like reference numerals refer to like elements throughout. The embodiment is described below to explain the present invention by referring to the figures.

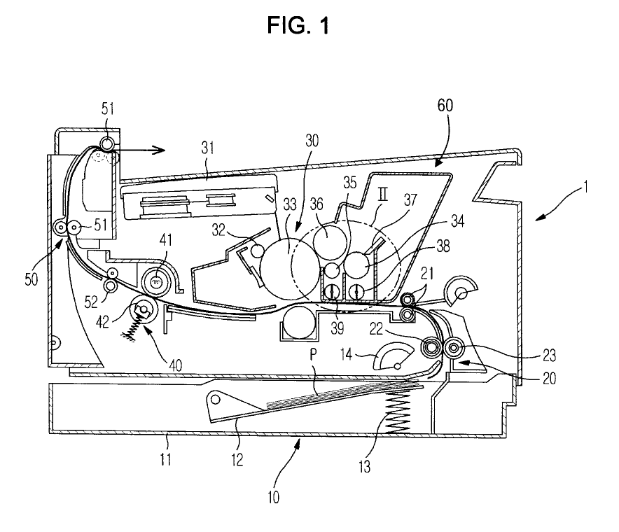

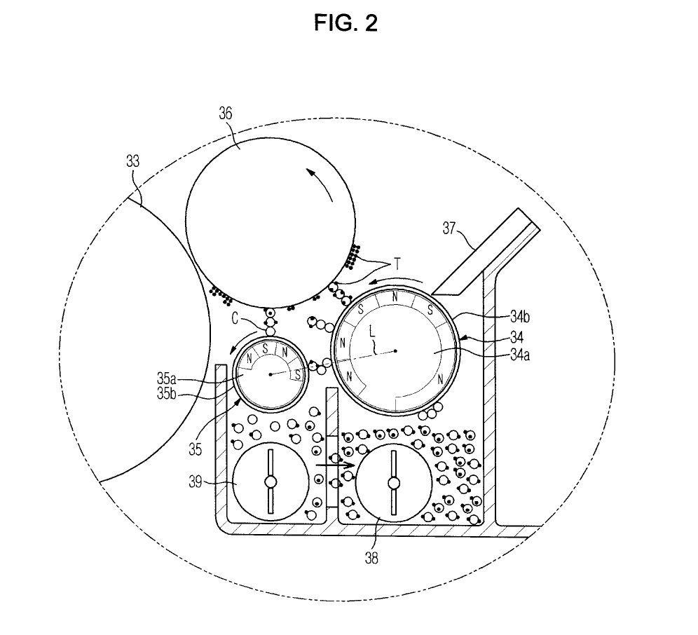

As shown in FIG. 1, an image forming apparatus according to the present embodiment includes a body 1 defining an outer appearance of the image forming apparatus and supporting a variety of parts mounted therein, a paper supply unit 10 to supply paper P as the printing medium, a delivery unit 20 to deliver the paper P, an image forming unit 30 to form an image on the paper P by means of developing agent composed of nonmagnetic toner T (See FIG. 2) and magnetic carrier C (See FIG. 2), a fixing unit 40 to fix the image, which was transferred onto the paper P by the image forming unit 30, and a paper discharge unit 50 to discharge the paper P out of the body 1.

The paper supply unit 10 includes a paper supply drawer 11 movably coupled to a lower portion of the body 1, the paper supply drawer 11 receiving the paper P, and a pressing plate 12 and a pressing spring 13, which are used to push the paper P received in the paper supply drawer 11 toward a pickup roller 14 located above the paper supply unit 10. If the paper P is brought into contact with the pickup roller 14 via an elastic force of the pressing spring 13, the paper P can be picked up, e.g., one sheet at a time, by the pickup roller 14, so as to be delivered to the delivery unit 20.

The delivery unit 20 is used to deliver the paper P, which was picked up by the pickup roller 14, so as to pass the paper P through the image forming unit 30. The delivery unit 20 includes a plurality of delivery rollers 21, and a register roller 22 and a register backup roller 23, which are used to align the leading end of the paper P in the course of delivering the paper P.

The image forming unit 30 includes an exposure member 31 to irradiate a laser beam containing image information, an image receiving member 33 on which an electrostatic latent image is formed by the laser beam from the exposure member 31, a charge roller 32 to charge the surface of the image receiving member 33, and a developing unit 60, which in turn includes magnetic rollers 34 and 35 to cause the carrier C to form magnetic brushes under a magnetic force, a donor roller 36 to form a layer of toner T on an outer circumference thereof when toner T is supplied thereto via the magnetic brushes formed on the magnetic rollers 34 and 35, and a trimmer 37 to control a thickness of the developing agent adhered to outer circumferential surfaces of the magnetic rollers 34 and/or 35. The developing unit 60 may additionally include a pair of agitators 38 and 39 are arranged below the respective magnetic roller 34 and 35. The agitators 38 and 39 agitate the developing agent, to allow the toner T to be electrostatically charged and to supply the charged developing agent to the magnetic rollers 34 and 35. The donor roller 36 is arranged to face and oppose the image receiving member 33 to form a development gap therebetween, at which gap the development of the electrostatic latent image on the image receiving member 33 using the toner T occurs.

The fixing unit 40 is used to fix a visible image to the paper P by applying heat and pressure to the paper P. The fixing unit 40 includes a heating roller 41 having a heat source to apply heat to the paper P, onto which the toner was transferred, and a pressing roller 42 arranged to oppose the heating roller 41, the pressing roller 42 maintaining a predetermined fixing pressure in a gap with the heating roller 41.

The paper discharge unit 50 includes a series of discharge rollers 51, which are sequentially arranged to discharge the paper P, which has passed through the fixing unit 40, from the body 1.

In the image forming apparatus according to the present invention, as shown in FIG. 2, in order to reduce a possible ghost phenomenon caused by residual toner T on the donor roller 36 that remains after the toner T is applied to the image receiving member 33, the plurality of magnetic rollers 34 and 35 are provided, to repeatedly collect the residual toner T from the donor roller 36.

The magnetic rollers 34 and 35 include a first magnetic roller 34, which is located at the front or upstream side (that is the side before the development gap at which the donor roller 36 faces the image receiving member 33) of the donor roller 36 along the rotational direction of the donor roller 36, and a second magnetic roller 35, which is located at the rear or downstream side (i.e., past the development gap) of the donor roller 36 along the direction of rotation of the donor roller 36. The second magnetic roller 35 is arranged to be spaced apart from the first magnetic roller 34 by a predetermined distance, so as to allow the second roller 35 to receive the carrier particles C from the first magnetic roller 34. Each of the magnetic rollers 34 and 35 includes a respective magnetic pole portion 34a and 35a and a respective rotating portion 34b and 35b. Each of the magnetic pole portions 34a and 35a is provided, Annear the outer circumference of the respective magnetic rollers 34 and 35, with N and S magnetic poles, e.g., as shown, to cause the carrier particles C to form the magnetic brush on the magnetic rollers 34 and 35 by the magnetic force generated from the magnetic poles. Each of the rotating portions 34b and 35b has a hollow cylindrical form and is rotatably installed around the respective magnetic pole portion 34a and 35a, to cause the carrier particles C and toner particles T, adhered to an outer circumferential surface thereof, and to move in a circumferential direction.

The first magnetic roller 34 can cause the carrier particles C to form the magnetic brush under the magnetic force resulting from the magnetic poles thereof, and supply the toner T to the donor roller 36 via the magnetic brush so as to form the layer of toner T on the donor roller 36. The first magnetic roller 34 can also collect residual toner particles T from the donor roller 36. The second magnetic roller 35 can cause the carrier C received from the first magnetic roller 34, to form the magnetic brush so as to collect residual toner T from the donor roller 36. In the case of the first magnetic roller 34, to transfer the toner T, which was electrostatically charged, to the donor roller 36, a predetermined bias may be applied to the first magnetic roller 34. To transfer the toner T from the donor roller 36 to the image receiving member 33, a predetermined bias may also be applied to the donor roller 36. Because the second magnetic roller 35 primarily serves to collect the toner T from the donor roller 36, it is not necessary to apply any bias to the second magnetic roller 35. The absence of bias applied to the second magnetic roller 35 should promote a more effective collection of residual toner particles T by the second magnetic roller 35 than the first magnetic roller that exhibits a bias to promote the toner particles to be supplied to the donor roller 36. While no bias is need to be applied to the second magnetic roller 35, and while the present invention is not so limited, a bias of opposite polarity to that of the first magnetic roller 34 may be applied to the second magnetic roller 35, which may promote an improved residual toner collecting capability of the second magnetic roller 35.

With the above-described configuration, a residue of toner T on the donor roller 36 can be collected once via the magnetic brush formed on the second magnetic roller 35, and can be collected further by the magnetic brush formed on the first magnetic roller 34. This repetitive collection also has the effect of significantly reducing a residual amount of toner T on the donor roller 36, and consequently, achieving a reduction in ghost phenomenon.

The image forming apparatus according to an embodiment may include a pair of agitators 38 and 39, to prevent deterioration, and thus shortened useful life, of the carrier C. The pair of agitators 38 and 39 includes a first agitator 38, which is disposed below the first magnetic roller 34, and which is used to transfer the toner T and carrier C toward the first magnetic roller 34, and a second agitator 39, which is disposed below the second magnetic roller 35, and which is used to transfer the toner T and carrier C, which were collected by the second magnetic roller 35, toward the first agitator 38.

With the above-described configuration, after the carrier C, which was collected by the second magnetic roller 35, is agitated by the second agitator 39, the carrier C is moved to the first agitator 38, so as to be transferred to the first magnetic roller 34 by the first agitator 38. This advantageously prevents a possible rapid deterioration of the carrier C caused when the collected carrier C is transmitted to the first magnetic roller 34 prior to being sufficiently agitated with new toner T, and results in an increase in the lifespan of the carrier C.

To allow the carrier C to be supplied from the first magnetic roller 34 to the second magnetic roller 35 so as to be used for collection of the toner T by the second magnetic roller 35, the magnetic poles of the first magnetic roller 34 are arranged in such a manner that a pair of magnetic poles, having the same polarity, are arranged, in parallel, on opposite sides of an imaginary line L that passes through the centers of the first and second magnetic rollers 34 and 35. In this case, one of the poles of the second magnetic roller 35, which has the polarity opposite to the above pair of magnetic poles of the first magnetic roller 34, is disposed along the imaginary line L. In the embodiment illustrated in FIG. 2, two N magnetic poles of the first magnetic roller 34 are provided on opposite sides of the imaginary line L, and an S magnetic pole of the second magnetic roller 35 is disposed on the imaginary line L.

With the above magnetic pole structure, the magnetic forces of the two N magnetic poles of the first magnetic roller 34 offset each other in a space between the two magnetic poles. Therefore, if the carrier C reaches the offset space, the first magnetic roller 34 applies no magnetic force to the carrier C because the magnetic forces of the two N magnetic poles offset each other, whereas the second magnetic roller 35 applies the magnetic force of the S magnetic pole to the carrier C. As a result, the carrier C is released from the first magnetic roller 34 and is transferred to the second magnetic roller 35.

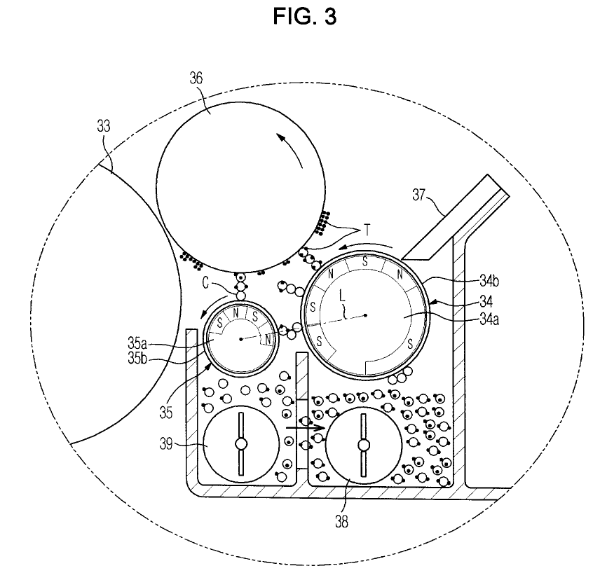

While the above-described embodiment illustrates the N magnetic poles arranged with respect to the first magnetic roller 34 and the S magnetic pole with respect to the second magnetic roller 35, it should apparent that alternative arrangement is also possible. For example, as shown in FIG. 3, an arrangement, in which S magnetic poles may be arranged at opposite sides of the imaginary line L with respect to the first magnetic roller 34 and an N magnetic pole may be disposed on the imaginary line L with respect to the second magnetic roller 35, is also possible.

As is apparent from the above description, the present invention provides an image forming apparatus including a plurality of magnetic rollers. With the use of the plurality of magnetic rollers, the present invention has the effect of effectively collecting a residual toner from the donor roller, and, consequently, reducing the occurrences of the ghost phenomenon.

Although the embodiment of the present invention has been shown and described, it would be appreciated by those skilled in the art that changes may be made in this embodiment without departing from the principles and spirit of the invention, the scope of which is defined in the claims and their equivalents.

What is claimed is:

1. An image forming apparatus, comprising:
an image receiving member having a surface on which an electrostatic latent image is to be formed;
a donor roller configured to receive toner, and to support a layer of toner on an outer circumferential surface thereof, the donor roller being arranged to opposingly face the image receiving member to allow the toner from the donor roller to be applied to the electrostatic latent image of the image receiving member; and
a plurality of magnetic rollers, each of which being arranged to face the donor roller, and being configured apply magnetic force to cause a magnetic brush of carrier to form thereon.

2. The image forming apparatus according to claim 1, wherein the donor roller and the image receiving member opposingly face each other to form a development gap therebetween, and
wherein the plurality of magnetic rollers comprises:
a first magnetic roller located at a first location, the first location being located before the development gap along a direction of rotation of the donor roller; and
a second magnetic roller located at a second location, the second location being located after the development gap along the direction of rotation of the donor roller.

3. The image forming apparatus according to claim 2, wherein the second magnetic roller is spaced apart from the first magnetic roller by a predetermined distance to allow the second magnetic roller to receive the carrier from the first magnetic roller.

4. The image forming apparatus according to claim 3, wherein:
the first magnetic roller comprises a pair of magnetic poles both of a first polarity, which are arranged, in parallel, on opposite sides of an imaginary line that passes through respective centers of the first and second magnetic rollers; and
wherein the second magnetic roller comprises a magnetic pole having a second polarity opposite the first polarity disposed along the imaginary line.

5. The image forming apparatus according to claim 2, further comprising:
a first agitator disposed below the first magnetic roller, the first agitator being configured to move the toner and the carrier toward the first magnetic roller; and
a second agitator disposed below the second magnetic roller, the second agitator being configured to move the toner and the carrier toward the first agitator.

6. An image forming apparatus, comprising:
an image receiving member having a surface on which an electrostatic latent image is to be formed;
a donor roller configured to receive toner, and to support a layer of toner on an outer circumferential surface thereof, the donor roller being arranged to opposingly face the image receiving member to allow the toner from the donor roller to be applied to the electrostatic latent image of the image receiving member;
a first magnetic roller to supply the toner to the donor roller; and
a second magnetic roller to collect residual toner that remains on the donor roller after the electrostatic latent image had been applied the toner thereto.

7. The image forming apparatus according to claim 6, wherein the donor roller and the image receiving member opposingly face each other to form a development gap therebetween,
wherein the first magnetic roller is located at a first location before the development gap along a rotating direction of the donor roller, and
wherein the second magnetic roller is located at a second location after the development gap along the rotating direction of the donor roller.

8. The image forming apparatus according to claim 7, wherein the second magnetic roller is spaced apart from the first magnetic roller by a predetermined distance to allow the second magnetic roller to receive the carrier from the first magnetic roller.

9. The image forming apparatus according to claim 8, wherein:
the first magnetic roller comprises a pair of magnetic poles both of a first polarity, which are arranged, in parallel, on opposite sides of an imaginary line that passes through respective centers of the first and second magnetic rollers; and
wherein the second magnetic roller comprises a magnetic pole having a second polarity opposite the first polarity disposed along the imaginary line.

10. The image forming apparatus according to claim 8, further comprising:
a first agitator disposed below the first magnetic roller, the first agitator being configured to move the toner and the carrier toward the first magnetic roller; and
a second agitator disposed below the second magnetic roller, the second agitator being configured to move the toner and the carrier toward the first agitator

11. The image forming apparatus according to claim 2, wherein:
the donor roller has applied thereto a first bias,
the first magnetic roller has applied thereto a second bias, and
wherein the second magnetic roller has no bias applied thereto.

12. The image forming apparatus according to claim 2, wherein:
the donor roller has applied thereto a first bias,
the first magnetic roller has applied thereto a second bias, and
wherein the second magnetic roller has applied thereto a third bias in opposite polarity of the first bias.

13. The image forming apparatus according to claim 6, wherein:
the donor roller has applied thereto a first bias,
the first magnetic roller has applied thereto a second bias, and
wherein the second magnetic roller has no bias applied thereto.

14. The image forming apparatus according to claim 6, wherein:
the donor roller has applied thereto a first bias,
the first magnetic roller has applied thereto a second bias, and
wherein the second magnetic roller has applied thereto a third bias in opposite polarity of the first bias.

15. A developer unit for developing, with developing agent that includes a mixture of nonmagnetic toner particles and magnetic carrier particles, an electrostatic latent image formed on an image receiving member of an image forming apparatus, the developer unit comprising:
a first magnetic roller configured to induce a first magnetic force to carry thereon a first magnetic brush formed of the magnetic carrier particles, the nonmagnetic toner particles being carried by the magnetic brush;
a donor roller disposed in proximity to, and spaced apart from, the first magnetic roller, the donor roller being rotatably mounted to rotate about a rotational axis in a rotational direction, the donor roller having an outer circumferential surface to receive the nonmagnetic toner particles from the magnetic brush of the first magnetic roller; and
a second magnetic roller disposed in proximity to, and spaced apart from, each of the donor roller and the first magnetic roller, the second magnetic roller being configured to receive from the first magnetic roller the magnetic carrier particles, the second magnetic roller further being configured to induce a second magnetic force to from thereon a second magnetic brush formed of the magnetic carrier particles, the second magnetic brush receiving nonmagnetic toner particles from the donor roller.

16. The developer unit according to claim 15, wherein:
the first magnetic roller comprises a pair of magnetic poles both of a first polarity, which are arranged, in parallel, on opposite sides of an imaginary line that passes through respective centers of the first and second magnetic rollers; and
wherein the second magnetic roller comprises a magnetic pole having a second polarity opposite the first polarity disposed along the imaginary line.

17. The developer unit according to claim 15, further comprising:
a first agitator disposed below the first magnetic roller, the first agitator being configured to move the nonmagnetic toner particles and the magnetic carrier particles toward the first magnetic roller; and
a second agitator disposed below the second magnetic roller, the second agitator being configured to move the nonmagnetic toner particles and the magnetic carrier particles toward the first agitator

18. The developer unit according to claim 15, wherein:
the donor roller has applied thereto a first bias,
the first magnetic roller has applied thereto a second bias, and
wherein the second magnetic roller has no bias applied thereto.

19. The developer unit according to claim 15, wherein:
the donor roller has applied thereto a first bias,
the first magnetic roller has applied thereto a second bias, and
wherein the second magnetic roller has applied thereto a third bias in opposite polarity of the first bias.
